(19) United States
(12) Patent Application Publication
(10) Pub. No.: US 2006/0285670 A1
(43) Pub. Date: Dec. 21, 2006

(54) Method and apparatus for providing conference call services

(75) Inventors: Frances Mu-Fen Chin, Naperville, IL (US); Peggy Hasan, Aurora, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/138,565

(22) Filed: May 26, 2005

(51) Int. Cl. H04M 3/42

(52) U.S. Cl. 379/201.01

(57) ABSTRACT

A method of scheduling and establishing a conference call in a telecommunications network including a conference call server and a database for storing conference call information. The method includes scheduling a conference call with at least one private chat room for a conference call originator, establishing the conference call with at least one private chat room, and disconnecting the conference call.

### BACKGROUND OF THE INVENTION

This invention relates to a method and apparatus for providing enhanced conference call services. While the invention is particularly directed to the art of telecommunications, and will be thus described with specific reference thereto, it will be appreciated that the invention may have usefulness in other fields and applications.

By way of background, despite the continued growth of the Internet, conference calling remains an important means of business communication and conducting business in the 21st century. Conference calls improve efficiency by reducing travel time and costs associated with face-to-face meetings. The establishment of a conventional conference call requires several steps. First, a day and time for the conference call must be established. This generally entails contacting each conference participant to determine common availability. After a date and time are set for the conference call, resources to facilitate the call must be reserved. For example, a conference bridge for an audio or video portion of the conference may be reserved. Also, attachments or exhibits, such as slides, video clips or other presentation aides, may be provided to conference participants, usually in advance of the day and time for the conference. Once the necessary resources are reserved and allocated for the conference call, conference access data may need to be supplied to each participant. For example, a conference bridge number and password may need to be distributed to conference participants to permit calling into the conference bridge. The steps described above complete the setup of the conference call. The actual conference call requires additional steps. Namely, each conference participant must connect to the conference call at the appropriate time with the appropriate capability to interact with other participants, including possibly the exchange of audio data, video data, files, conference presentation materials and the like.

Typically, a conference calling session is established through the use and assistance of an outside operator. All a business owner needs to do is call up the operator, provide the numbers of those people to be included in the conference calling session and provide the operator the date and time of the session. The phone company does the rest.

Another form of conference calling that is gaining in popularity because it allows for virtually unlimited access to the conference calling session is one in which those interested in participating the in the conference calling session are provided a toll free number that they can call to be added into the conference calling session. These types of call in conference calling sessions have become widely popular with businesses and governmental officials who want to make public announcements or hold media and press conferences over the phone.

Nonetheless, in all of these situations, conference call participants (assuming at least some of the participants are calling from different locations) cannot hold a private discussion during a conference call without the possibility of other parties hearing the conversation. This problem may cause inconvenience to certain participants and may prevent issues from being resolved during the existing conference call. For example, during a bid proposal or contract review, the conference call participants from one company may need to talk to each other to reach a consensus among them and then rejoin the original conference call to continue the contract negotiations.

Thus, there is a need in the art for a method and apparatus to provide conference call participants with a private chat room beforehand and allow certain participants with password access to activate the private discussion during the conference call.

### SUMMARY OF THE INVENTION

Methods and apparatus for conference call scheduling and establishment are provided. In one aspect of the invention there is provided a method of establishing a conference call in a telecommunications network including a server for conference call scheduling and establishment and a database for storing conference call information. The method includes scheduling a conference call with at least one private chat room for a conference call originator, establishing the conference call with at least one private chat room, and disconnecting the conference call.

Scheduling a conference call may further include receiving a request for a conference call from the conference call originator, the request including conference call information, querying the conference call originator as to whether at least one private chat room should be set up for use during the conference call and whether the conference call originator agrees to pay for this extra service, instructing the conference call originator to choose the total number of ports for each private chat room, determining whether there are sufficient resources for the conference call based upon the number of ports chosen by the conference call originator, when there are sufficient resources for the conference call, assigning a first procedure for establishing the conference call and a second procedure for establishing at least one private chat room during the conference call, setting up a conference call profile for the conference call and storing the profile in the database, and notifying the conference call originator of procedures.

Establishing the conference call may include receiving an indication from a participant in the conference call that a private chat room should be established, querying the participant for the correct password to enter the private chat room, receiving input from the participant concerning the password, determining whether the participant has input the correct password, and where the correct password has been input by the participant, connecting the participant to the private chat room.

In another aspect of the present invention, there is provided an apparatus including scheduling means for scheduling a conference call with at least one private chat room for a conference call originator, establishing means for establishing the conference call with at least one private chat room, and disconnecting means for disconnecting the conference call.

The scheduling means may include receiving means for receiving a request for a conference call from the conference call originator, the request including conference call information, querying means for querying the conference call originator as to whether at least one private chat room should be set up for use during the conference call and whether the conference call originator agrees to pay for this extra service, instructing means for instructing the conference call originator to choose the total number of ports for each private chat room, determining means for determining whether there are sufficient resources for the conference call based upon the number of ports chosen by the conference call originator, assigning means for assigning a first procedure for establishing the conference call and a second procedure for establishing at least one private chat room during the conference call when there are sufficient resources for the conference call, set-up means for setting up a conference call profile for the conference call and storing the profile in a database, and notifying means for notifying the conference call originator of the procedures.

The establishing means may include receiving means for receiving an indication from a participant in the conference call that a private chat room should be established, querying means for querying the participant for the correct password to enter the private chat room, receiving means for receiving input from the participant concerning the password, determining means for determining whether the participant has input the correct password, and connecting means for connecting the participant to the private chat room where the correct password has been input by the participant.

In another aspect of the present invention, there is provided an apparatus for providing conference call services comprising in a network for connecting users for voice and multimedia communications. The apparatus includes a server for conference call scheduling and establishment, a database in communication with the server for storing conference call information, and means for facilitating communication between a user and the server. Further, the server is programmed to schedule a conference call with at least one private chat room for a conference call originator, establish the conference call with at least one private chat room, and disconnect the conference call.

The server may also be programmed to receive a request for a conference call from the conference call originator, the request including conference call information, query the conference call originator as to whether at least one private chat room should be set up for use during the conference call and whether the conference call originator agrees to pay for this extra service, instruct the conference call originator to choose the total number of ports for each private chat room, determine whether there are sufficient resources for the conference call based upon the number of ports chosen by the conference call originator, assign a first procedure for establishing the conference call and a second procedure for establishing at least one private chat room during the conference call when there are sufficient resources for the conference call, set up a conference call profile for the conference call and storing the profile in a database, and notify the conference call originator of the procedures.

The server may be further programmed to receive an indication from a participant in the conference call that a private chat room should be established, query the participant for the correct password to enter the private chat room, receive input from the participant concerning the password, determine whether the participant has input the correct password, and connect the participant to the private chat room where the correct password has been input by the participant.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings.

FIG. 1 is a block diagram of a multimedia services network that provides conference call services in accordance with aspects of the present invention.

FIG. 2 is a memory layout of data stored in the database in accordance with aspects of the present invention.

FIG. 3 is a flow chart illustrating a method for scheduling conference call services in accordance with aspects of the present invention.

FIG. 4 is a flow chart illustrating a method for establishing a prescheduled conference call in accordance with aspects of the present invention.

FIG. 5 is a block diagram showing several layers of private chats during a conference call in accordance with aspects of the present invention.

### DESCRIPTION OF THE PREFERRED EMBODIMENTS

Referring now to the drawings wherein the showings are for purposes of illustrating the preferred embodiments of the invention only and not for purposes of limiting same, FIG. 1 is a block diagram of a telecommunication network 10 suitable for implementing aspects of the present invention.

Included in FIG. 1 is a first communication device 12, which is shown as an ordinary telephone equipped to handle, for example, voice communications. The telephone 12 is operatively connected to the Public Switched Telephony Network (PSTN) 14. The PSTN 14 refers to the public telephone networks as we know them and is composed of switches and T1/E1 trunks, central offices, etc., all as known to those skilled in the art. The PSTN 14 uses circuit-switched technology in which necessary resources are allocated (dedicated) for the duration of a phone call.

A second communication device 16 is also shown in FIG. 1. The second communication device 16 is shown as a wireless device (or a mobile station), which includes a user interface. The second communication device 16 typically includes a user interface and an interface for coupling to the radio access network (RAN). The user interface of the second communication device 16 is typically referred to as terminal equipment and generally includes an audio interface, such as a microphone and speakers, a visual interface, such as a display, and a user input interface, such as a keyboard or touch pad. The interface for coupling to the RAN is typically referred to as a mobile terminal and generally includes an over-the-air interface for transmitting and receiving data. The over-the-air interface of communication device 16 is used to communicate with any number of base stations 18 in the RAN. The communication device 16 and the base stations 18 in the RAN may communicate over-the-air using various transmission methods, including packet-based protocols.

The base station 18 is generally a central radio transmitter/receiver, which maintains communications with the wireless communication devices 16 within a given range (typically a cell site). The base station 18 is coupled to a mobile switching center (MSC) 20, which is generally a switch that provides services and coordination between mobile users in a network and external networks.

The MSC 20 is a processor-based apparatus with data link interfaces for coupling together as described above and shown in FIG. 1. The MSC 20 includes one or more processors that execute programs to implement the functionality described herein and generally associated with wireless systems. The flexibility of this processor-based system permits ready integration into this system of a private conference calling chat room method and system in accordance with the present invention. Such a processor-based system commonly includes a high speed processing unit (CPU) in conjunction with a memory system (with volatile and/or nonvolatile memory), an input device, and an output device, all as well known to those skilled in the art.

The MSC 20 is essentially a switching element that routes calls and performs call handling functions. Although only one MSC 20 is shown in the figure, it is to be understood that the telecommunications system 10 may include any number of MSCs that are spaced geographically apart. The MSC 20 routes calls by accessing information in a subscriber database 22, such as a home location register (HLR). It should also be understood that switching elements of different types may be used in networks that vary from the example network 10.

The subscriber database 22 typically contains subscriber/customer profile information, and it may also contain mobility management information, in the case of wireless networks. The subscriber database 22 may maintain at least two types of subscriber information: subscription information and location information. Subscription information refers to the services that each subscriber is authorized to use under the subscriber's calling plan, including conference calling services. The subscriber database 22 uses the subscription information to verify that the subscriber is authorized for certain types of services. One type of location information is the last MSC that was registered as serving the subscriber. This is stored in the form of a mobile switching center identification number, which identifies the appropriate MSC. Other location information is used to calculate tax on the cost of a call, for example. In addition, the subscriber is identified using a mobile identification number Location information is used to properly route and bill the call.

FIG. 1 also shows a third communication device 26 operatively connected to the conference call server 30 via the Internet 28 as known in the art. The third communication device 26 optionally employs a wireless local area network (WLAN) or wire line, in the usual manner, to operatively connect to the Internet 28.

An IP (Internet Protocol) network such as the Internet 28, in contrast to the PSTN 6, is composed of nodes of computers, servers, routers, and communications links, etc. It employs packet-switching technology that decomposes data (e.g., voice, Web sites, e-mail messages) into IP packets. Each packet is then transmitted over an IP network to a destination identified by an IP address and reassembled at the destination. An IP transmission is completed without pre-allocating resources from point to point.

Only three communication devices (12, 16, and 26) are shown in FIG. 1 for the purpose of simplifying the diagram. However, it is to be appreciated that any number of such communication devices may be situated in the telecommunications system 10. Additionally, while each is depicted as a specific type of communication device, other like devices may also be incorporated.

The telecommunication network 10 also includes a conference call server (CCS) 30. A function of the conference call server 30 is to facilitate conference calls between users of the communication devices shown in FIG. 1. The conference call server 30 generally includes a CPU (not shown) such as a microprocessor or a secure server, and is in communication with a special database 32 for storing pertinent information for conference calls.

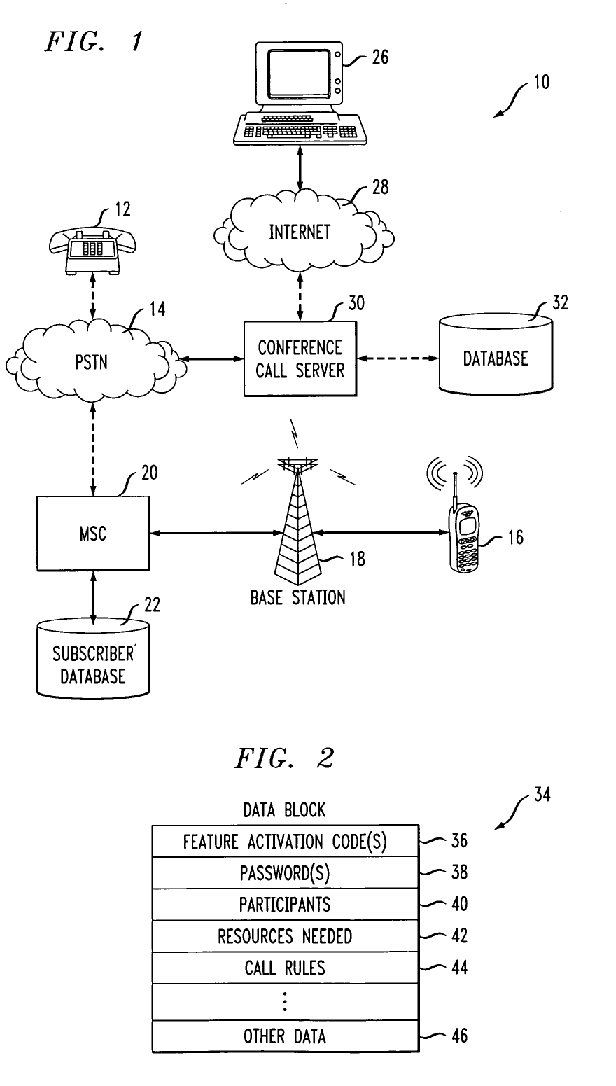

The database 32 includes any number of data sub-blocks for each conference call. These are shown in FIG. 2. They are shown as a super block 34, not all of whose fields are filled for a particular conference call. The super block, as known in the art, can be accessed from the identity of any one of several fields in the super block. The super block 34 includes data sub-blocks, including a first sub-block 36 that contains feature activation code data, a second sub-block 38 that contains password data, a third sub-block 40 that contains data concerning the participants in the conference call, a fourth sub-block 42 that contains data relating the resources needed for the conference call, and a fifth sub-block 44 that contains call rules data. Of course, any number of additional sub-blocks 46 may be provided in the super block 34 for storing other data.

The processing functions to be accomplished by the conference call server 30 are generally described in a program and recorded in a computer-readable recording medium so that by executing the program by the CPU, the above-described processing can be executed. In this regard, the CPU preferably includes memory (not shown), for example, a hard disk, a dynamic random access memory (DRAM), a read-only memory (ROM), etc. for storing the necessary computer code. The CPU executes the computer code necessary for implementing the conference calling methods described in greater detail below.

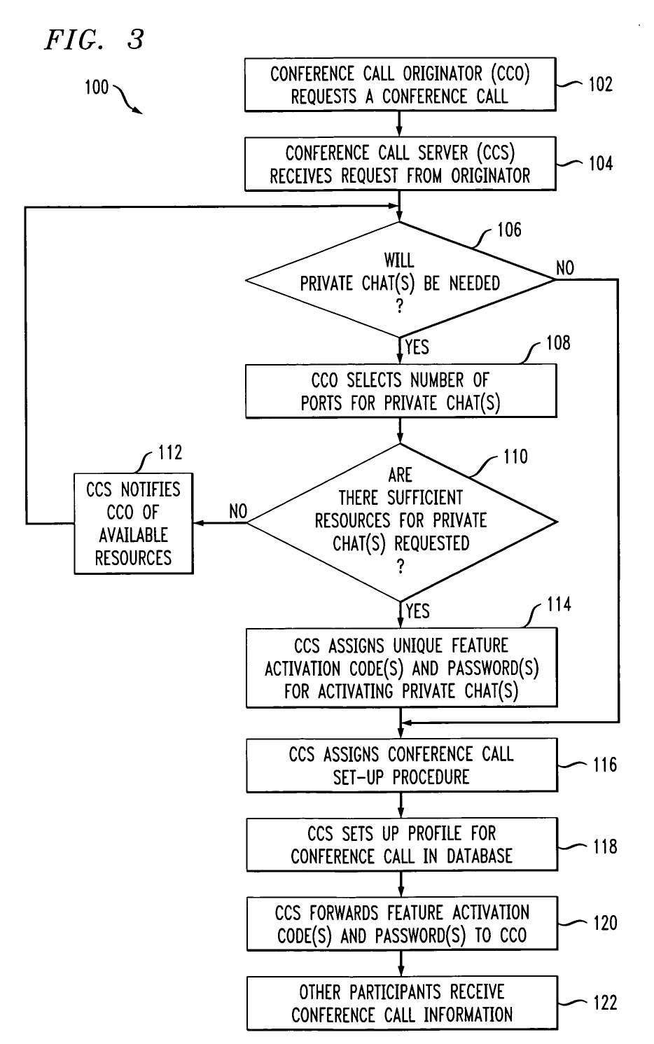

FIG. 3 is a flow chart illustrating a method for scheduling a conference call in accordance with the present invention. FIG. 3 is described below with reference to the preferred embodiment shown in FIG. 1. The method for scheduling a conference call preferably begins when a conference call originator (CCO) enters a conference call request (102). The request may be made via the first or second communication devices 12, 16. Alternatively, the request may be in the form of a Web page interface accessible by the third communication device 26 or any other terminal device that couples to the network 10 via the Internet 28. The request is received, and the method is executed, by the conference call server 30 or implemented by any processor-based apparatus discussed above or shown in FIG. 1 (104).

The initial request from the conference call originator may include preliminary information pertaining to the conference call such as a list of participants, an indication of resources desired for the call, and rules for the conference call. Alternatively, the conference call server 30 may query the originator for the preliminary information after the request has been received. Some information may be designated as critical, indicating that the particular information or resource may be necessary for the conference call. For example, a speaker that will present information on the conference call may be designated a critical participant, since without the speaker the information will not be presented. The list of participants preferably includes contact information for the participants, such as a telephone number or IP address. The resources specified for a call include conference bridge circuits, audio and video mixing circuits, software necessary for sharing files and other information, or any other resources desired or needed for the conference call. The rules for the conference call generally include limitations on the call, for example, a time of day or a particular day of week, as well as the possible need for one or more private chats during the conference call.

Once the initial request has been received, the conference call server 30 queries the conference call originator as to whether one or more private chat rooms should be set up for private chats among any number of participants during the conference call, including whether the originator agrees to pay for this extra service (step 106). If the answer to both questions is yes, then the conference call originator is instructed to choose the total number of ports for each private chat room (108). For example, if there will be four users from different phone lines participating in a private chat, then four ports will be reserved.

Once the information concerning the conference call is received from the originator, including information relating to one or more private chats, the conference call server 30 performs certain tasks, including initiating a check on the availability of the necessary resources, as specified in the request (110). Resource availability is preferably determined by assessing resources necessary based on the participants, resources and rules associated with the request. After an assessment of the necessary resources, functions supplying those resources are queried for availability. The availability information associated with resources is returned to the conference call server 30.

If the resource check indicates that there are not enough ports to meet the request, then the conference call server 30 will notify the originator (112) and ask the originator to reenter the request (106). The originator may want to reduce the number of conference call participants or eliminate the private chat request.

If the conference call server 30 completes all of the checks and determines that there are sufficient resources available, then the server 30 assigns one or more unique feature activation codes and passwords for activating the private chat(s) (114). The conference call server 30 also assigns the standard conference call set-up procedure (116). The conference call server 30 sets up a conference call profile for the conference call originator and stores the profile in the database 32 (118).

The conference call server 30 notifies the conference call originator of the feature activation codes for the conference call (e.g., *89 for the conference call and *889 to initiate a private chat) as well as any passwords that are to be used for the call (120).

Meanwhile, the conference call participants are notified of the conference date and time and any additional information needed for setup of the conference call (122). The notification to the conference participants may be conveyed via a text message, audio message, video message, interactive multimedia session, or a combination of these, by the conference call originator or the conference call server 30. For example, any one of the communication devices in the network 10 that is suitably equipped may receive a text message indicating a date and time for a conference call, a listing of attributes for the call, such as audio, video, and a request for confirmation of availability. Any materials associated with the conference call, such as presentation materials or files, are sent to users with the notification of the conference date and time.

On the other hand, if the answer to either of the inquiries in step 106 is no, the conference call server 30 assigns the standard conference call setup procedure for the call (116) and forwards this information to the conference call originator as set forth above.

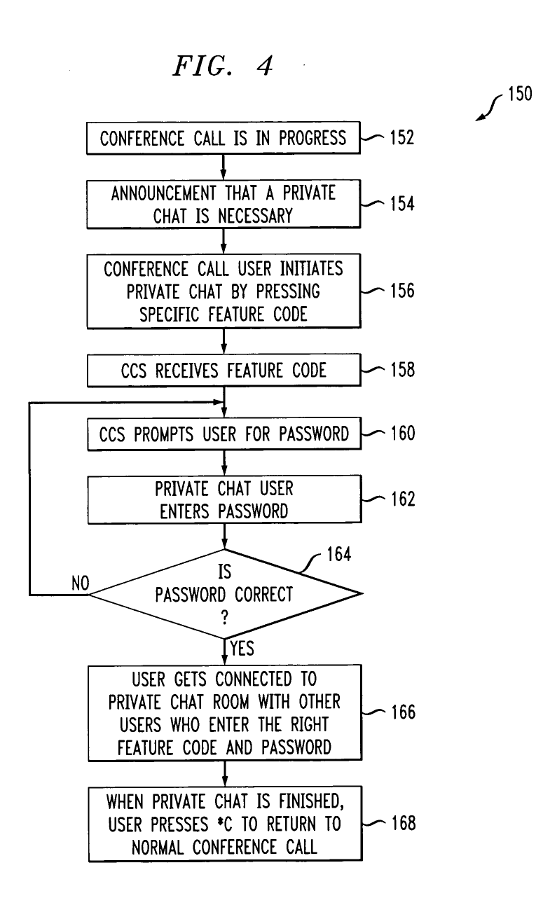

FIG. 4 is a flow chart illustrating a method 150 for establishing a prescheduled conference call in accordance with the present invention. Preferably, the conference call server 30 executes the method for establishing the prescheduled conference call in coordination with the necessary resources for the call. Thus, the conference call server 30 receives any input necessary for the conference call, including, but not limited to, participants, rules (e.g., private chats), resources and the time and date for the conference call. Preferably, this information is generated as a result of execution of the method described above with respect to FIG. 3. Alternatively, the conference call information may have been entered directly by a user.

Initially, the conference call is established and is in progress (152). The conference call participants may contact the conference call server 30 to join the call. Alternatively, once the conference time approaches, a notification may be sent to the participants. For example, five minutes prior to a schedule conference call, each participant may receive a notification via email, a text message, an audio message, a video message, an interactive multimedia session, or a combination of these, to indicate that a conference call will begin in five minutes. The notification may include an option for at least critical participants to confirm availability for the approaching conference. If required confirmations are not received, then a conference call requester is notified of the unavailability of a critical participant. Also, unavailability of a critical resource may require a similar notification to a conference requester. The conference requester may elect to proceed or not proceed with the conference call. An election to proceed preferably includes sending conference access instructions to unconfirmed participants to allow these participants to join in the call when they are available. An election to not proceed further results in the conference call being canceled, and all participants are notified of the cancellation.

At this point, the conference call has been established and is in progress. Thus, during the conference call, if one of the pre-selected participants needs to talk privately, a notification is sent to at least one of the other parties on the conference call that a private talk is necessary and request that some of the parties join a private chat (154). The notification can be in various forms, such as a public announcement to all of the callers from one of the callers or an automated message from the conference call server 30, a private announcement directed only to the pre-selected group of participants (again, live or automated), or a signal, e.g., a double click to only the pre-selected participants.

The pre-selected participants can then press the appropriate feature activation code, such as *889, to initiate the private chat (156). The conference call server 30 receives the feature activation code (158), and then prompts the user for the password (160). The user then enters the password (162). Next, the conference call server 30 determines whether the password is correct by querying the database 26 (164). If the password entered by the user is correct, then the user is connected to the private chat room with each user that has entered the correct feature activation code and the correct password (166).

On the other hand, if the password entered is incorrect, then the user is prompted, once again, for the proper password (160). This process repeats for a pre-determined number of times or until the proper password is entered.

When the private talk is completed, the private talk participants can end the call by any known means, such as by pressing a feature activation code (e.g., *C) to return to the regular conference call (step 168).

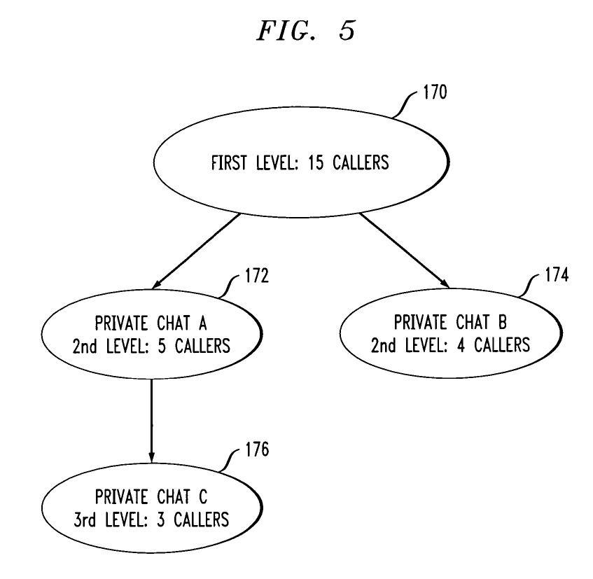

The aforementioned private chat room can also be set up for more than one private group, as shown in FIG. 5. The conference call originator can request more than one private chat room if needed. Each private chat room will be assigned a unique password.

For example, let us assume that the conference call originator has set up the conference call for fifteen callers in the first level 170. Thus, in this example, the conference call server 30 allocates fifteen ports for the first level. The conference call originator has requested a private chat in a first private chat room 172, where the private chat contains five callers from the first level 170. The conference call server 30 allocates five ports for the first chat room 172. The conference call originator has also requested a second private chat in a second private chat room 174, where the private chat contains up to four callers from the first level 170. The conference call server 30 allocates four ports for the second private chat room 174. Finally, the conference call originator has requested a private chat in a third private chat room 176 from the group of callers in the first chat room 172, where the private chat contains three callers from the first private chat room 172. In this instance, the conference call server 30 would allocate three additional ports. Thus, in total, the conference call server 30 would allocate twenty-seven ports internally for this conference call.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. In a telecommunications network including a server for conference call scheduling and establishment and a database for storing conference call information, a method comprising:
scheduling a conference call with at least one private chat room for a conference call originator;
establishing the conference call with at least one private chat room; and
disconnecting the conference call.

2. The method defined in claim 1, wherein scheduling a conference call further comprises:
receiving a request for a conference call from the conference call originator, the request including conference call information;
querying the conference call originator as to whether at least one private chat room should be set up for use during the conference call and whether the conference call originator agrees to pay for this extra service;
instructing the conference call originator to choose the total number of ports for each private chat room;
determining whether there are sufficient resources for the conference call based upon the number of ports chosen by the conference call originator;
when there are sufficient resources for the conference call, assigning a first procedure for establishing the conference call and a second procedure for establishing at least one private chat room during the conference call;
setting up a conference call profile for the conference call and storing the profile in the database; and
notifying the conference call originator of procedures.

3. The method defined in claim 1, wherein establishing the conference call further comprises:
receiving an indication from a participant in the conference call that a private chat room should be established;
querying the participant for the correct password to enter the private chat room;
receiving input from the participant concerning the password;
determining whether the participant has input the correct password; and
where the correct password has been input by the participant, connecting the participant to the private chat room.

4. The method defined in claim 2, wherein establishing the conference call further comprises:
receiving an indication from a participant in the conference call that a private chat room should be established;
querying the participant for the correct password to enter the private chat room;
receiving input from the participant concerning the password;
determining whether the participant has input the correct password; and
where the correct password has been input by the participant, connecting the participant to the private chat room.

5. The method defined in claim 4, wherein the conference call information includes at least one off a list of participants, resources desired for the call, and rules for the conference call.

6. The method defined in claim 5, further comprising:
sending a notification via email, a text message, an audio message, a video message, or an interactive multimedia session to indicate that a conference call will begin.

7. An apparatus comprising:
scheduling means for scheduling a conference call with at least one private chat room for a conference call originator;
establishing means for establishing the conference call with at least one private chat room; and
disconnecting means for disconnecting the conference call.

8. The apparatus defined in claim 7, wherein the scheduling means further comprises:
receiving means for receiving a request for a conference call from the conference call originator, the request including conference call information;
querying means for querying the conference call originator as to whether at least one private chat room should be set up for use during the conference call and whether the conference call originator agrees to pay for this extra service;
instructing means for instructing the conference call originator to choose the total number of ports for each private chat room;
determining means for determining whether there are sufficient resources for the conference call based upon the number of ports chosen by the conference call originator;
assigning means for assigning a first procedure for establishing the conference call and a second procedure for establishing at least one private chat room during the conference call when there are sufficient resources for the conference call;
set-up means for setting up a conference call profile for the conference call and storing the profile in a database; and
notifying means for notifying the conference call originator of the procedures.

9. The apparatus defined in claim 7, wherein the establishing means further comprises:
receiving means for receiving an indication from a participant in the conference call that a private chat room should be established;
querying means for querying the participant for the correct password to enter the private chat room;
receiving means for receiving input from the participant concerning the password;
determining means for determining whether the participant has input the correct password; and
connecting means for connecting the participant to the private chat room where the correct password has been input by the participant.

10. The apparatus defined in claim 8, wherein the establishing means further comprises:
receiving means for receiving an indication from a participant in the conference call that a private chat room should be established;
querying means for querying the participant for the correct password to enter the private chat room;
receiving means for receiving input from the participant concerning the password;
determining means for determining whether the participant has input the correct password; and
connecting means for connecting the participant to the private chat room where the correct password has been input by the participant.

11. The apparatus defined in claim 10, wherein the conference call information includes at least one off a list of participants, resources desired for the call, and rules for the conference call.

12. The apparatus defined in claim 11, further comprising:
sending means for sending a notification via email, a text message, an audio message, a video message, or an interactive multimedia session to indicate that a conference call will begin.

13. In a network for connecting users for voice and multimedia communications, an apparatus for providing conference call services comprising:
a server for conference call scheduling and establishment;
a database in communication with the server for storing conference call information; and
means for facilitating communication between a user and the server, where the server is programmed to:
schedule a conference call with at least one private chat room for a conference call originator;
establish the conference call with at least one private chat room; and
disconnect the conference call.

14. The apparatus defined in claim 13, wherein the server is further programmed to:
receive a request for a conference call from the conference call originator, the request including conference call information;
query the conference call originator as to whether at least one private chat room should be set up for use during the conference call and whether the conference call originator agrees to pay for this extra service;
instruct the conference call originator to choose the total number of ports for each private chat room;
determine whether there are sufficient resources for the conference call based upon the number of ports chosen by the conference call originator;
when there are sufficient resources for the conference call, assign a first procedure for establishing the conference call and a second procedure for establishing at least one private chat room during the conference call;
set up a conference call profile for the conference call and storing the profile in a database; and
notify the conference call originator of the procedures.

15. The apparatus defined in claim 13, wherein the server is further programmed to:
receive an indication from a participant in the conference call that a private chat room should be established;
query the participant for the correct password to enter the private chat room;
receive input from the participant concerning the password;
determine whether the participant has input the correct password; and
where the correct password has been input by the participant, connect the participant to the private chat room.

16. The apparatus defined in claim 14, wherein the server is further programmed to:
receive an indication from a participant in the conference call that a private chat room should be established;
query the participant for the correct password to enter the private chat room;
receive input from the participant concerning the password;
determine whether the participant has input the correct password; and
where the correct password has been input by the participant, connect the participant to the private chat room.

17. The apparatus defined in claim 16, wherein the conference call information includes at least one off a list of participants, resources desired for the call, and rules for the conference call.

18. The apparatus defined in claim 17, wherein the server is further programmed to:
send a notification via email, a text message, an audio message, a video message, or an interactive multimedia session to indicate that a conference call will begin.
